(19) United States
(12) Patent Application Publication
(10) Pub. No.: US 2008/0116181 A1
(43) Pub. Date: May 22, 2008

(54) Apparatus and method for laser cutting

(76) Inventors: Der-Chun Wu, Padeh City (TW); De-Jiun Li, Padeh City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/882,634

(22) Filed: Aug. 3, 2007

(30) Foreign Application Priority Data
Nov. 17, 2006 (TW) 95142674

(51) Int. Cl. B23K 26/38; B23K 26/14

(52) U.S. Cl. 219/121.72; 219/121.67

(57) ABSTRACT

An apparatus for laser cutting having two laser sources and the method thereof are provided for the assembly substrate. An Yttrium Aluminum Garnet (YAG) laser is used to execute the cutting-off process for the positions without the terminals and the outer-edge positions of the terminals of the assembly substrate, and an Infra-Red (IR) laser is used to execute the cutting process for the inner-edge positions of the terminals of the assembly substrate. The YAG laser and the IR laser can be operated at different time or at the same time.

### BACKGROUND OF THE INVENTION

1. Field of the Invention

The present invention relates to an apparatus and a method for laser cutting, and more particularly, to provide an apparatus for laser cutting and the method thereof for an assembly substrate.

2. Description of the Prior Art

The Thin Film Transistor-Liquid Crystal Display (TFT-LCD) is the most popular flat panel display at present. It has many advantages such as low power consumption, thin shape, light weight, and low driving voltage, etc.

Generally, an LCD panel is constituted by two substrates, a Thin Film Transistor (TFT) substrate and a Color Filter (CF) substrate, having electrodes thereof. The liquid crystal is filled between two substrates, and the electrical field formed between the electrodes of the two substrates will affect the arrangement of the liquid crystal and so as to control the brightness of the display picture.

Recently, the large-scale glass substrates are widely used in the manufacturing process to reduce cost and time for promoting the productivity. Several pieces of TFT substrates and CF substrates are respectively included in two corresponding large-scale glass substrates. Firstly, the manufacturing processes for the TFT substrates and the CF substrates are performed in advance, then adhering the corresponding TFT substrate and the CF substrate into an assembly substrate using a glue. And then, the assembly substrate is cut into several discrete LCD panels to proceed the follow-up processes, such as the liquid crystal injection and the end seal, etc.

FIG. 1 is a schematic diagram of an adhered assembly substrate before cutting, the CF substrate 102 is adhered on the TFT substrate 104 to form an assembly substrate 100. There will be four discrete LCD panels 10, 20, 30, 40 after the cutting process. The a₁-a₁′, a₂-a₂′, d₁-d₁′ and d₂-d₂′ represent the cutting lines without terminals, the assembly substrate 100 will be cut off after cutting. The b₁-b₁′, b₂-b₂′, e₁-e₁′ and e₂-e₂′ represent the cutting lines of the inner-edge position of the terminals, the CF substrate 102 will be cut to the interface adhered to the TFT substrate 104 after cutting. The c₁-c₁′, c₂-c₂′, f₁-f₁′ and f₂-f₂′ represent the cutting lines of the outer-edge positions of the terminals, the assembly substrate 100 will be cut off after cutting.

FIG. 2 is a schematic diagram of a discrete LCD panel after accomplishing the cutting process of the adhered assembly substrate shown in FIG. 1, the CF substrate 12 is adhered on the TFT substrate 14. There are exposed terminals 16, which are used to electrically connect to outside driving circuits (not shown in the figure), on the surface of the TFT substrate 14. And the cut-off leads 18 are connected to the outer edges of the terminals 16.

It is more and more popular to use a laser to cut the large-scale assembly substrate recently. An Infra-Red (IR) laser is used for most of the laser cutting, but a cutting way using a solid-state Yttrium Aluminum Garnet (YAG) laser has been developed by some vendors presently.

Because the Infra-Red (IR) laser, which is a CO₂ laser with wavelength 10.6 micrometers, can only penetrate into the depth of several micrometers under the surface of the glass substrate and which is not able to penetrate through. It means more than 95% of the incident energy will be absorbed by the surface of the glass substrate, so it can be used to cut the inner-edge positions of the terminals. As shown in FIG. 3, an IR laser head 112 is fixed in a movable holder 110. Its emitted laser beam 114 focuses on the surface of the CF substrate 102 and moves along the cutting line b₁-b₁′ of the inner-edge position of the terminals to form a crack, so the CF substrate 102 will be broken off along the crack to the interface adhered to the TFT substrate 104 after the cutting process.

However, it needs to cut twice if using the IR laser to cut the positions without the terminals or the outer-edge positions of the terminals. The processes are complex and the tack time is long. Furthermore, turning over the large-scale assembly substrate is easy to make it fractured or damaged.

Therefore, the positions without the terminals and the outer-edge positions of the terminals of the assembly substrate are suitable for adopting the solid-state YAG laser. The solid-state YAG laser with 1.064 micrometers can penetrate the assembly substrate thoroughly, and about 15% of the incident energy that can cut off the assembly substrate will be absorbed. Thus, it can be used to simultaneously cut the positions without the terminals or the outer-edge positions of the terminals of the assembly substrate. As shown in FIG. 4, a solid-state YAG laser 116 is fixed in a movable holder 110. Its emitted laser beam 118 penetrates through the assembly substrate 100 and moves along the cutting line without terminals a₁-a₁′, so the assembly substrate 100 is cut thoroughly along the cutting line without terminals a₁-a₁′ to accomplish this cutting process.

Nevertheless, the solid-state YAG laser is not suitable to cut the inner-edge positions of the terminals of the assembly substrate because it will penetrate through the glass.

Consequently, the apparatus for laser cutting having only a laser source can not simultaneously satisfy all the cutting requirements of the assembly substrate, which includes cutting the positions without the terminals, the outer-edge and inner-edge positions of the terminals.

### SUMMARY OF THE INVENTION

In order to solve the aforementioned problem of only using an IR laser to cut the outer-edge positions of the terminals or the positions without the terminals of the assembly substrate which processes are complex, risky, and time-consuming, one object of the present invention is to provide an apparatus for laser cutting having two laser sources and the method thereof. Thereby, the outer-edge positions of the terminals and the positions without the terminals of the assembly substrate can adopt a solid-state YAG laser to execute the cutting-off process. Relatively, the inner-edge positions of the terminals of the CF-side assembly substrate can adopt an IR laser with approximate zero absorption for glass to achieve the object of not turning over the assembly substrate.

In order to solve the aforementioned problem that the conventional single solid-state YAG laser will penetrate through the glass and so as not to be suitable for the cutting of the inner-edge positions of the terminals of the CF-side assembly substrate, one object of the present invention is to provide an apparatus for laser cutting having two laser sources and the method thereof. Thereby, the inner-edge positions of the terminals of the assembly substrate can adopt an IR laser to execute the cutting process.

In order to solve the aforementioned problem that the apparatus for laser cutting having only a single laser source can not simultaneously satisfy all the cutting requirements of the assembly substrate including cutting the positions without the terminals, the outer-edge and inner-edge positions of the terminals, one object of the present invention is to provide an apparatus for laser cutting having two laser sources and the method for laser cutting thereof. Thereby, the different cutting positions can adopt suitable lasers to execute the cutting processes at different time or at the same time.

Consequently, the apparatus for laser cutting and the method thereof for the assembly substrate of the present invention can substantially reduce the cutting cost and time and effectively promote the cutting yield and quality.

To achieve the objects mentioned above, one embodiment of the present invention is to provide an apparatus for laser cutting and the method thereof. A solid-state YAG laser is used to execute the cutting-off process for the positions without the terminals or the outer-edge positions of the terminals of the assembly substrate, and an IR laser is used to execute the cutting process for the inner-edge positions of the terminals of the assembly substrate. The YAG laser and the IR laser can be operated at different time or at the same time to achieve the object of saving tack-time.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram of an adhered assembly substrate before cutting in the prior art.

FIG. 2 is a schematic diagram of a discrete LCD panel after accomplishing the cutting process of the adhered assembly substrate shown in FIG. 1.

FIG. 3 is a schematic diagram for cutting the inner-edge positions of the terminals of the assembly substrate using an IR laser in the prior art.

FIG. 4 is a schematic diagram for cutting off the positions without the terminals of the assembly substrate using a solid-state YAG laser in the prior art.

FIG. 5 is a schematic diagram for cutting off the positions without the terminals of the assembly substrate using a solid-state YAG laser according to one embodiment of the present invention.

FIG. 6 is a schematic diagram for using a solid-state YAG laser, and an IR laser to respectively execute the cutting-off process for the outer-edge positions of the terminals of the assembly substrate, and the cutting process for the inner-edge positions of the terminals of the assembly substrate at the same time according to one embodiment of the present invention.

FIG. 7 is a partial amplified schematic diagram of FIG. 6.

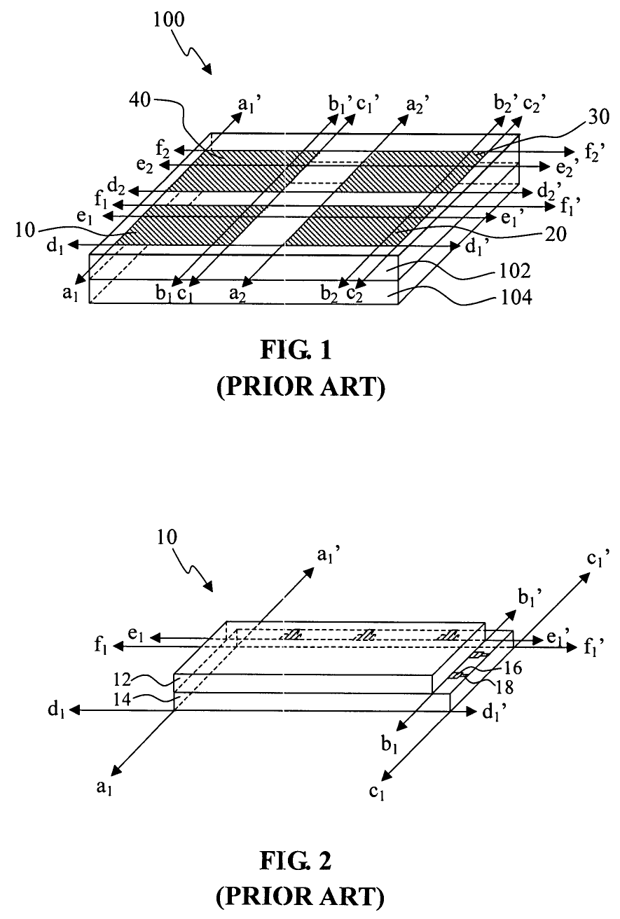

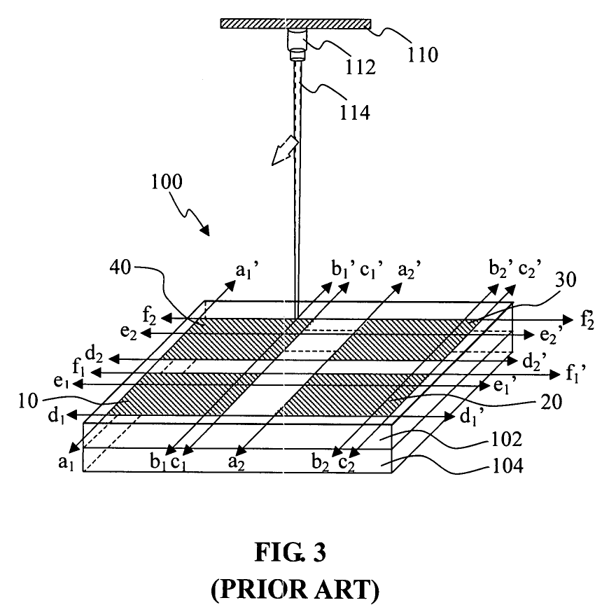

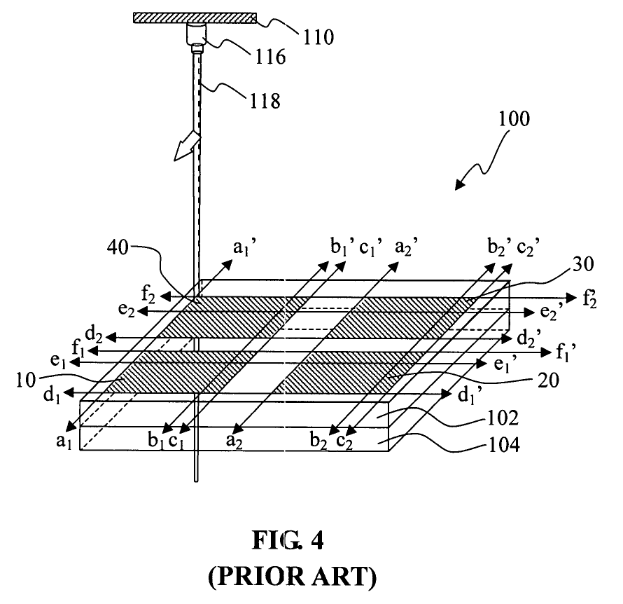

### DESCRIPTION OF THE PREFERRED EMBODIMENT

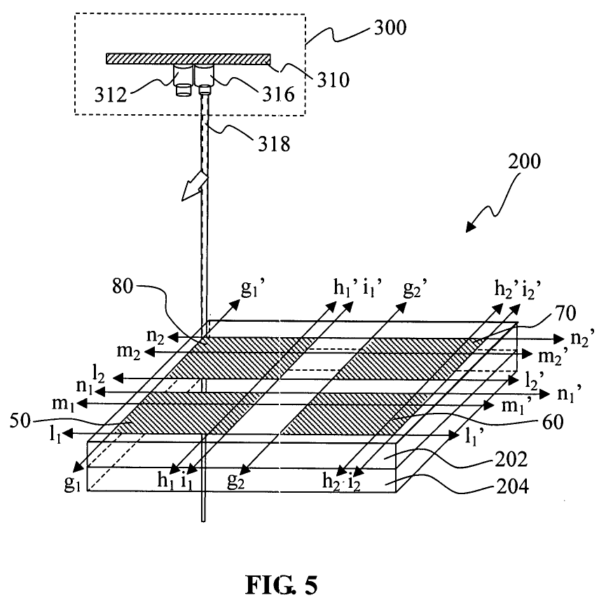

FIG. 5 is a schematic diagram according to one embodiment of the present invention that an apparatus for laser cutting having two laser sources is applied for the cutting of the assembly substrate. The apparatus for laser cutting 300 includes an IR laser 312 and a solid-state YAG laser 316, both are fixed in a movable holder 310. In one embodiment, the IR laser 312 is a CO₂ laser with wavelength 10.6 micrometers, and the wavelength of the solid-state YAG laser is 1.064 micrometers.

The CF substrate 202 is adhered on the TFT substrate 204 to form an assembly substrate 200. There will be four discrete LCD panels 50, 60, 70, 80 after cutting. The laser beam 318 emitted from the solid-state YAG laser 316 penetrates through the assembly substrate 200 and moves along the cutting line without terminals g₁-g₁′ to cut off the assembly substrate 200. Likewise, the solid-state YAG laser 316 can be used to execute the cutting-off processes for other cutting lines without terminals g₂-g₂′, l₁-l₁′, l₂-l₂′. Similarly, the solid-state YAG laser 316 can also be used to execute the cutting-off processes for the cutting lines i₁-i₁′, i₂-i₂′, n₁-n₁′ and n₂-n₂′ of the outer-edge positions of the terminals. The IR laser 312 is used to execute the cutting process of the cutting lines h₁-h₁′, h₂-h₂′, m₁-m₁′ and m₂-m₂′ of the inner-edge positions of the terminals, so the CF substrate 202 will be broken off to the interface adhered to the TFT substrate 204 along the surface crack of the cutting lines h₁-h₁′, h₂-h₂′, m₁-m₁′ and m₂-m₂′ after the cutting process.

Therefore, one feature of the present invention is combining two different laser sources in one apparatus for laser cutting. Thereby, the different cutting positions can adopt suitable laser to execute the cutting process.

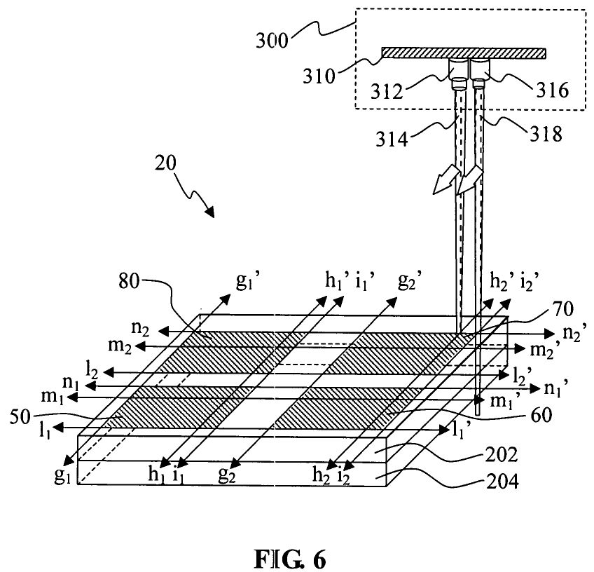

The IR laser 312 and the solid-state YAG laser 316 can be respectively operated for different cutting positions at different time or at the same time according to the different demands. FIG. 6 is a schematic diagram according to one embodiment of the present invention that two laser sources are operated at the same time. The laser beam 318 emitted from the solid-state YAG laser 316 penetrates through the assembly substrate 200 and moves along the cutting line i₂-i₂′ of the outer-edge position of the terminals, and the laser beam 314 emitted from the IR laser 312 focuses on the surface of the CF substrate 202 and moves along the cutting line h₂-h₂′ of the inner-edge position of the terminals. The solid-state YAG laser 316 and the IR laser 312 are respectively used to execute the cutting-off process for the outer-edge positions of the terminals and the cutting process for the inner-edge positions of the terminals at the same time.

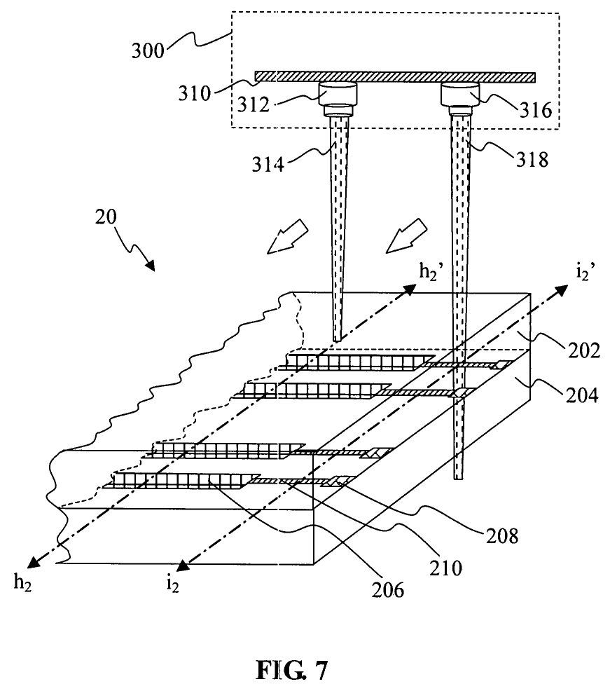

FIG. 7 is a partial amplified schematic diagram of FIG. 6. On the surface of the TFT substrate 204, there are terminals 206 to electrically connect to outside driving circuits (not shown in the figure) and short rings 208 to prevent the possible static-electricity damage during the manufacturing processes before cutting. Besides, the leads 210, which are passed by the cutting line i₂-i₂′ of the outer-edge position of the terminals, are used to electrically connect the terminals 206 and the short rings 208. Because the leads 210 have high transmittance to the visible light or the Ultra-Violate (UV) light, so the solid-state YAG laser 316 can be applied to execute the cutting-off process for the outer-edge positions of the terminals.

Please refer to FIG. 6 again. Likewise, the cutting/cutting-off processes for all the cutting lines of the inner-edge/outer-edge positions, h₁-h₁′/i₁-i₁′, m₁-m₁′/n₁-n₁′ and m₂-m₂′/n₂-n₂′, can be accomplished at the same time. After accomplishing all the cutting processes including the cutting-off processes of the positions without the terminals and the outer-edge positions of the terminals, and the cutting processes of the inner-edge positions of the terminals, four discrete LCD panels 50, 60, 70, 80 which have finished the cutting can be obtained.

It is to be understood that the present embodiment of may also be arranged to execute the cutting-off process for the positions without the terminals of the assembly substrate and the cutting process for the inner-edge positions of the terminals of the assembly substrate at the same time. For instance, the solid-state YAG laser 316 and the IR laser 312 can respectively execute the cutting-off process for the cutting line without terminals g₂-g₂′ and the cutting process for the cutting line h₂-h₂′ of the inner-edge position at the same time.

Therefore, one feature of the present invention is that two different laser source, in the apparatus for laser cutting can respectively execute the cutting-off process for the outer-edge positions of the terminals or the positions without the terminals of the assembly substrate, and the cutting process for the inner-edge positions of the terminals of the assembly substrate at the same time.

In addition, the more lasers being executed simultaneously, the less manufacturing time is needed and so as to promote the efficiency and the productivity. Therefore, in one embodiment of the present invention, the cutting apparatus may have more than two solid-state YAG lasers or more than two IR lasers.

Consequently, the apparatus for laser cutting and the method for laser cutting thereof for the assembly substrate of the present invention can substantially reduce the cutting cost and time and effectively promote the cutting yield and quality.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the Claims appended hereto and their equivalents.

What is claimed is:

1. An apparatus for laser cutting applied to cut an assembly substrate, comprising:
a solid-state Yttrium Aluminum Garnet (YAG) laser;
an Infra-Red (IR) laser; and
a movable holder to fix the solid-state YAG laser and the IR laser.

2. The apparatus for laser cutting according to claim 1, wherein a laser beam emitted from the solid-state YAG laser is used to cut off an outer-edge position of a terminal or a position without the terminal of the assembly substrate.

3. The apparatus for laser cutting according to claim 1, wherein the wavelength of the solid-state YAG laser is 1.064 micrometers.

4. The apparatus for laser cutting according to claim 1, wherein a laser beam emitted from the IR laser is used to cut an inner-edge position of the terminal of the assembly substrate.

5. The apparatus for laser cutting according to claim 1, wherein the IR laser is a CO₂ laser with wavelength 10.6 micrometers.

6. A method for laser cutting applied to cut an assembly substrate, comprising:
providing the assembly substrate, the assembly substrate comprising:
a Thin Film Transistor (TFT) substrate, wherein a surface of the TFT substrate comprises a plurality of terminals; and
a Color Filter (CF) substrate adhered on the surface of the TFT substrate;
applying a first laser beam to cut off an outer-edge position of a terminal or a position without the terminal of the assembly substrate; and
applying a second laser beam to cut an inner-edge position of the terminals of the assembly substrate, wherein the wavelength of the second laser beam is different from the wavelength of the first laser beam.

7. The method for laser cutting according to claim 6, wherein the first laser beam is emitted from a solid-state YAG laser.

8. The method for laser cutting according to claim 7, wherein the wavelength of the solid-state YAG laser is 1.064 micrometers.

9. The method for laser cutting according to claim 6, wherein the second laser beam is emitted from an IR laser.

10. The method for laser cutting according to claim 9, wherein the IR laser is a CO₂ laser with wavelength 10.6 micrometers.

11. The method for laser cutting according to claim 6, wherein the first laser beam and the second laser beam are applied to execute the cutting-off process and the cutting process at the same time.
